(19) United States
(12) Patent Application Publication
(10) Pub. No.: US 2014/0205222 A1
(43) Pub. Date: Jul. 24, 2014

(54) Systems and Methods for Preventing Electrical Arcing Between Components of Rotor Bearings

(71) Applicant: Baker Hughes Incorporated, Houston, TX (US)

(72) Inventors: Stephen G. Biggs, Claremore, OK (US); Doran J. Jackson, Claremore, OK (US)

(73) Assignee: Baker Hughes Incorporated, Houston, TX (US)

(21) Appl. No.: 14/161,376

(22) Filed: Jan. 22, 2014

Related U.S. Application Data
(60) Provisional application No. 61/756,085, filed on Jan. 24, 2013.

(51) Int. Cl. F16C 41/00

(52) U.S. Cl. CPC F16C 41/002
USPC 384/276

(57) ABSTRACT

Systems and methods for reducing or preventing electrical arcing within rotor bearings in induction motors by positioning an electrically conductive ring between the outer race and the housing of the bearing. In one embodiment, a bearing has a cylindrical housing within which an outer race is positioned. An inner race is positioned coaxially within the outer race and rotates within the outer race. An electrically conductive ring is positioned between the outer race and the housing to allow electrical current to be conducted between them. This prevents electrical potential from building up between the outer race and the housing, and prevents arcing between them. The conductive ring may be formed by joining the two ends of a coil spring to form a loop around the outer race. The spring may be positioned in a groove in the outer periphery of the outer race.

### CROSS-REFERENCE TO RELATED APPLICATIONS

This application claims the benefit of U.S. Provisional Patent Application 61/756,085, filed Jan. 24, 2013, which is incorporated by reference as if set forth herein in its entirety.

### BACKGROUND

1. Field of the Invention

The invention relates generally to rotor bearings, and more particularly to rotor bearings that employ a conductive ring between a housing and an outer race within the bearing.

2. Related Art

Oil and natural gas are often produced by drilling wells into oil reservoirs and then pumping the oil and gas out of the reservoirs through the wells. If there is insufficient pressure in the well to force these fluids out of the well, it may be necessary to use an artificial lift system in order to extract the fluids from the reservoirs. A typical artificial lift system employs an electric submersible pump which is positioned in a producing zone of the well to pump the fluids out of the well.

An electric submersible pump system includes a pump and a motor which is coupled to the pump and drives the pump. The electric submersible pump system may also include seals, gauge packages and other components. Because they are designed to fit within the borehole of a well, electric submersible pump systems are typically less than ten inches wide, but may be tens of meters long. The motor of an electric submersible pump system may produce hundreds of horsepower.

The motor of the electric submersible pump system is typically an AC induction motor. The motor has a stator that is cylindrical with a coaxial bore. A rotor is coaxially positioned within the bore of the stator. The rotor is coupled to a shaft so that rotation of the rotor turns the shaft. Bearings hold the rotor in position within the bore of the stator and allow the rotor to rotate smoothly within the bore.

During the normal operation of an induction motor, a voltage may develop between the shaft and stator. Because the rotor bearings are positioned between the shaft and stator, the voltage difference between the shaft and stator may cause electrical arcs to occur within the bearing. For instance, electrical submersible pump motors have shown signs of arcing between the housings of rotor bearings and the carbide inserts (outer races) in the bearings. Increased use of Pulse Width Modulation (PWM) type motor controllers has made this problem more common and acute.

The occurrence of electrical arcs within the rotor bearings can cause damage to the components of the bearings. The electrical arcs may, for example, cause the surfaces of the components to be pitted, and may cause small particles to break away from the surfaces. The oil flowing through the bearings may carry these particles to other parts of the bearing, and to other parts of the motor, causing increased wear to the bearings and other motor components and shortening the life of the motor.

### SUMMARY OF THE INVENTION

This disclosure is directed to systems and methods for reducing or preventing electrical arcing within rotor bearings in induction motors. This is accomplished by positioning an electrically conductive ring between the outer periphery of the bearing's outer race and the inner diameter of the bearing's housing.

One embodiment comprises a bearing for an electric motor. The bearing has a cylindrical housing within which an outer race is positioned. An inner race is positioned coaxially within the outer race and the inner race rotates within the outer race. One or more electrically conductive rings are positioned between the outer race and the housing. The conductive rings make electrical contact with the outer race and the housing, so that electrical current is conducted between the outer race and the housing. As a result, electrical potential does not build up between the outer race and the housing, and arcing between the outer race and the housing is prevented. In one embodiment, the conductive ring comprises a coil spring. The two ends of the coil spring are welded together to form a loop around the outer race. A groove may be formed in an outer periphery of the outer race so that the conductive ring can be positioned within the groove. The conductive ring may provide an interference fit between the outer race and the housing, preventing the outer race from rotating within the housing. One or multiple conductive rings may be positioned between the outer race and the housing.

An alternative embodiment comprises a system that includes a downhole electric motor. The motor has a stator with a bore therethrough. A rotor is mounted on a shaft and is rotatably positioned within the bore of the stator. One or more bearings are installed in the motor to support the shaft and rotor within the stator bore and enable the shaft and rotor to rotate freely within the stator bore. Each of the bearings includes at least one electrically conductive ring positioned between the outer race and the housing to make electrical contact with the outer race and the housing. The conductive rings prevent an electrical potential from developing between the outer race and the housing, and thereby prevent arcing between the outer race and the housing. Interference rings (e.g., elastomeric T-rings) may be positioned between the stator and the housing of the bearing to provide an interference fit between the housing and the stator. The motor may be coupled to an electric submersible pump so that the motor drives the pump.

Another alternative embodiment comprises a method for reducing electrical arcs between components of a bearing for an electric motor. In this method, the components of a bearing, including a housing, an inner race and an outer race are provided. At least one electrically conductive ring is positioned between the outer race and the housing, so that the conductive ring makes electrical contact with the outer race and the housing. The inner race is positioned coaxially within the outer race, so that the inner race rotates within the outer race. The bearing is then installed in an electric motor, wherein the bearing supports a shaft and a rotor within a stator bore and enables the shaft and rotor to rotate freely within the stator bore. The method may include forming a groove in an outer periphery of the outer race and positioning the conductive ring within the groove. The method may further comprise forming the conductive ring by joining the ends of a coil spring so that the coil spring forms a loop (the conductive ring) around the outer race.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating some of the primary components of an electric submersible pump system.

FIG. 2 is a diagram illustrating the structure of an exemplary motor suitable for use in an electric submersible pump system.

FIG. 3 is a more detailed diagram illustrating the structure of an exemplary motor suitable for use in an electric submersible pump system.

FIG. 4 is a diagram illustrating the structure of an exemplary rotor bearing having a conductive ring installed between the housing and an insert that forms the outer race of the bearing.

FIG. 5 is a diagram illustrating the structure of an alternative rotor bearing having multiple conductive rings installed between the housing and an insert that forms the outer race of the bearing.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention. Further, the drawings may not be to scale, and may exaggerate one or more components in order to facilitate an understanding of the various features described herein.

### DESCRIPTION OF EXEMPLARY EMBODIMENTS

Various embodiments of the invention are described below. It should be noted that these and any other embodiments described below are exemplary and are intended to be illustrative of the invention rather than limiting.

As described herein, various embodiments of the invention comprise systems and methods for preventing electrical arcing within rotor bearings in induction motors. Arcing between the housings and outer race inserts of the bearings is prevented by using an electrically conductive ring that fits between the outer diameter of the insert and the inner diameter of the housing.

One embodiment of the present invention is implemented in an electric submersible pump motor. The motor has multiple rotor bearings that hold a rotor in position within the bore of a stator and allow the rotor to rotate smoothly within the stator. Each of the rotor bearings has a housing within which an insert is installed. The insert forms an outer race that remains stationary within the housing. A conductive ring is provided between the housing and the outer race to carry electrical current between these components and prevent electrical arcs between them. An inner race is positioned coaxially within the outer race and supports the motor shaft as it rotates within the outer race.

Conventionally, o-rings are positioned between the insert that forms the outer race and the housing of the bearing. These o-rings are typically made of rubber or a similar elastomeric material that electrically insulates the insert from the housing. This allows an electrical potential to develop between the housing and insert, which may cause arcing between the housing and insert. In one embodiment of the present invention, however, a conductive replacement for the conventional o-ring is used. For example, a metal coil spring may be curved into a loop and used in place of the elastomeric o-ring. The spring provides elasticity similar to that of the o-ring, but provides an electrically conductive path between the housing and the insert which prevents any significant electrical potential from developing between the housing and the insert, thereby preventing arcing between these components and the damage that could result from the arcing.

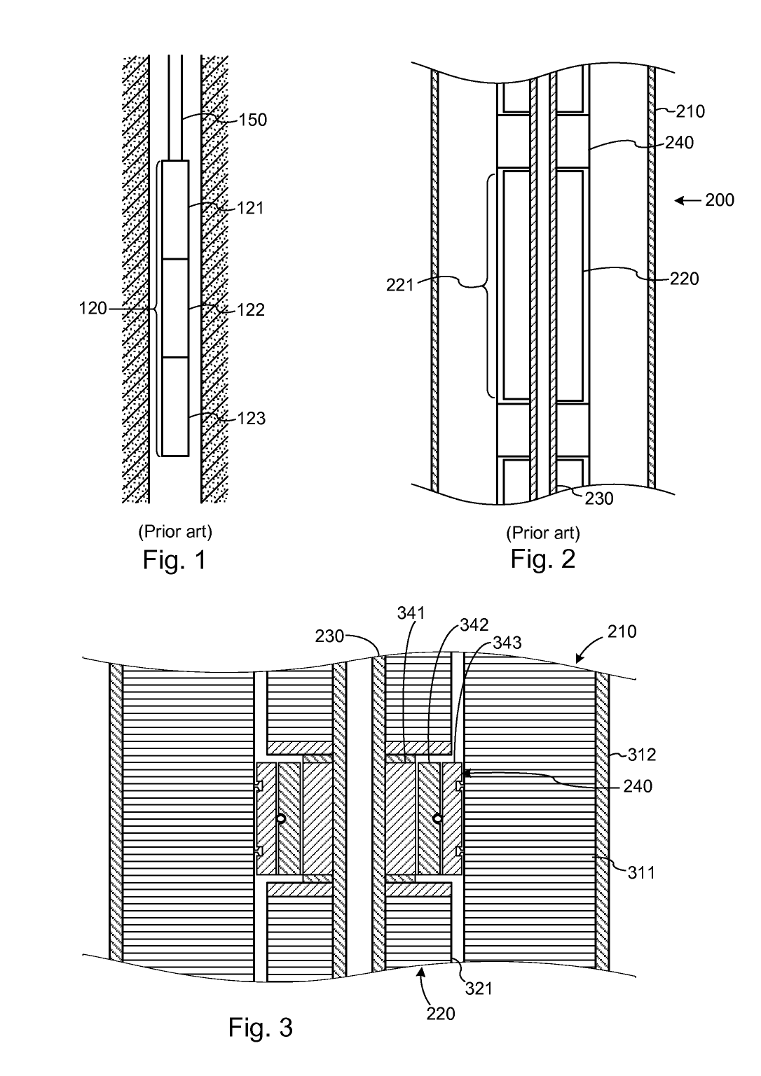

Embodiments of the invention may be implemented, for example, in electric submersible pump systems. Referring to FIG. 1, a diagram illustrating the components of an electric submersible pump system in one embodiment. In this embodiment, an electric submersible pump system is implemented in a well for producing oil, gas or other fluids. An electric submersible pump system 120 is coupled to the end of tubing string 150, and the electric submersible pump system and tubing string are lowered into the wellbore to position the pump in a producing portion of the well. A drive system (not shown) at the surface of the well provides power to the electric submersible pump system 120 to drive the system's motor.

Electric submersible pump system 120 includes a pump section 121, a seal section 122, and a motor section 123. Electric submersible pump system 120 may include various other components which will not be described in detail here because they are well known in the art and are not important to a discussion of the invention. Motor section 123 is coupled by a shaft through seal section 122 to pump section 121. Motor section 123 rotates the shaft, thereby driving pump section 121, which pumps the oil or other fluid through the tubing string 150 and out of the well.

Referring to FIG. 2, a diagram illustrating the structure of an exemplary motor suitable for use in an electric submersible pump system is shown. As depicted in this figure, motor 200 has a stator 210 and a rotor 220. Stator 210 is generally cylindrical, with a coaxial bore that runs through it. Rotor 220 is coaxially positioned within the bore of stator 210. Rotor 220 is attached to a shaft 230 that is coaxial with the rotor and stator 210. In this example, rotor 220 includes multiple sections (e.g., 221), where bearings (e.g., 240) are positioned at the ends of each section. The bearings 240 support shaft 230, and consequently rotor 220, within the bore of stator 210 and allow the rotor and shaft 230 to rotate within the stator.

Referring to FIGS. 3 and 4, a pair of diagrams illustrating the structure of motor 200 in more detail is shown. It can be seen in this figure that stator 210 is formed by stacking a set of thin, substantially identical plates or laminations (e.g., 311). The laminations 311 are generally annular in shape, so that when they are stacked together, they form a generally cylindrical shape, with a coaxial, cylindrical bore in the center. The diameter of the bore of the stator 210 may be referred to herein as the inner diameter of the stator. The stacked laminations 311 are pressed into a housing 312 to form the stator assembly 210. It should be noted that the laminations 311 need not be exactly identical. Similarly, the laminations 311 need not be perfectly annular (for example, the laminations may form a key or keyway that mates with a corresponding structure of housing 312 to prevent the stacked laminations from rotating within the housing).

The construction of rotor 220 is similar to that of stator 210, in that the rotor sections are formed by stacking corresponding sets of laminations (e.g., 321). The laminations 321 are again essentially annular, having an outer diameter that is slightly less than the inner diameter of stator 220, and an inner diameter that is substantially equal to the outer diameter of shaft 230. Each set of laminations 321 is stacked and shaft 230 is positioned through the bore formed through the stacked rotor laminations. The shaft 230 and laminations 321 may be keyed to prevent the laminations from rotating with respect to the shaft.

Rotor 220 is held in position within stator 210 by the rotor bearings (e.g., 240). As noted above, there are multiple bearings, each of which is positioned between (or at an ends of) the rotor sections. Thrust washers (360, 361) are positioned between bearing 240 and the end plates (370, 371) of the rotor sections.

Each bearing in this embodiment has an inner race 341 that fits within an outer race 342. Inner race 341 fits against and rotates with shaft 230. Inner race 341 rotates within outer race 342. Outer race 342 fits within a bearing housing 343. Outer race 342 remains stationary with respect to housing 343, and housing 343 itself remains essentially stationary within the bore of stator 210. Elastomeric T-rings 380 and 381 are positioned in grooves in the outer periphery of housing 343 to provide an interference fit between the housing and the stator. This keeps the bearing properly positioned in the stator 210 and prevents the housing from rotating with respect to the stator. O-rings or other types of interference rings may be used in alternative embodiments to maintain the position of the bearings within the stator bore.

Outer race 342 in this embodiment is a carbide insert that fits within housing 343. Outer race 342 has a groove 351 in its outer periphery 352 (the radially outward-facing surface). A conductive ring 350 is positioned within groove 351. Conductive ring 350 serves to maintain the position of outer race 342 within housing 343, and to prevent the outer race from rotating within the housing. Conductive ring 350 also conducts electrical current between the outer race 342 and the housing 343. Because conductive ring 350 extends around the circumference of outer race 342, it may provide lower electrical resistance than if a single point of contact between the components were provided. Additionally, any current flowing through conductive ring 350 between outer race 342 and housing 343 may be distributed over a greater extent and may therefore reduce any damage that might be caused by this current.

In one embodiment, conductive ring 350 is a coil spring. The coil spring 350 is curved into a loop, and the ends of the spring are welded together to maintain the looped shape. Conductive ring 350 is sized to extend radially outward from the outer periphery of outer race 342 to a diameter that is slightly larger than the inner diameter of housing 343. Conductive ring 350 thereby provides an interference fit between outer race 342 and housing 343. The natural elasticity of the conductive ring (e.g., coil spring) 350 provides an outward force against on the housing 343, thereby preventing the outer race 342 from rotating within the housing.

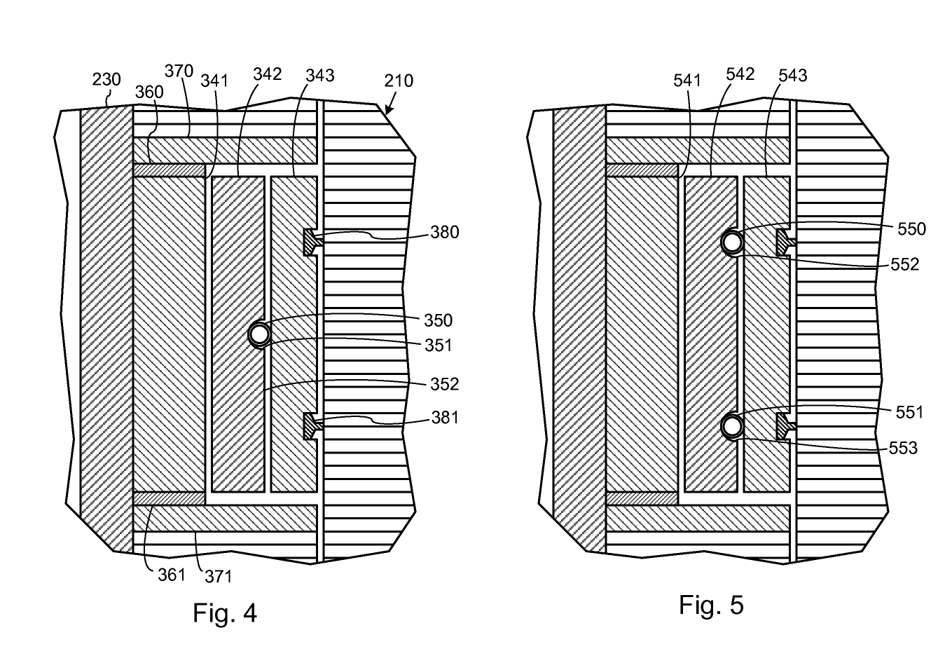

Referring to FIG. 5, a diagram illustrating the structure of a rotor bearing in accordance with an alternative embodiment is shown. In this embodiment, the bearing again includes an inner race 541 within an outer race 542, and a bearing housing 543 into which outer race 542 is inserted. In this embodiment, outer race 542 includes two conductive rings (550, 551) that are seated in corresponding grooves (552, 553) in the outer periphery of the outer race. The use of two conductive rings instead of a single ring may provide greater electrical conductivity between the housing and the outer race, and may provide greater resistance to physical movement (e.g., rotation) of the outer race within the housing.

It should be noted that there may be many alternative embodiments. For example, embodiments may include rotor bearings, motors (e.g., electric submersible pump motors) that utilize bearings as described above, methods of manufacturing or using bearings having the described features, and so on. Alternative embodiments may also include many variations of the features described above. For instance, there may be one or multiple conductive rings, the rings may replace conventional o-rings or may be used in addition to conventional o-rings, the rings may have coil spring structures or other structures, the rings may be formed using metal or other conductive materials, and so on. Still other variations may be apparent to those of skill in the art upon reading this disclosure.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the described embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed herein.

What is claimed is:

1. A bearing for an electric motor, the bearing comprising:
a cylindrical housing;
an outer race positioned within the housing, wherein at least one electrically conductive ring is positioned between the outer race and the housing, wherein the at least one conductive ring makes electrical contact with the outer race and the housing and conducts electrical current between the outer race and the housing; and
an inner race positioned coaxially within the outer race, wherein the inner race rotates within the outer race.

2. The bearing of claim 1, further comprising a groove in an outer periphery of the outer race, wherein the at least one conductive ring is positioned within the groove.

3. The bearing of claim 1, wherein the at least one conductive ring comprises a coil spring.

4. The bearing of claim 3, wherein the coil spring has two ends that are joined together to form a loop around the outer race.

5. The bearing of claim 1, wherein the at least one conductive ring provides an interference fit between the outer race and the housing, and wherein the at least one conductive ring prevents the outer race from rotating within the housing.

6. The bearing of claim 1, wherein the at least one conductive ring comprises a plurality of conductive rings, wherein each one of the plurality of conductive rings is positioned between the outer race and the housing and is in electrical contact with the outer race and the housing.

7. A system comprising:
a downhole motor;
wherein the motor includes
a stator having a bore therethrough,
a rotor mounted on a shaft, wherein the rotor and shaft are rotatably positioned within the bore of the stator, and
one or more bearings, wherein each of the bearings is positioned within the stator bore, wherein the one or more bearings support the shaft and rotor within the stator bore and enable the shaft and rotor to rotate freely within the stator bore; and
wherein each of the one or more bearings includes a cylindrical housing, an outer race positioned within the housing, and an inner race positioned coaxially within the outer race, wherein at least one electrically conductive ring is positioned between the outer race and the housing, wherein the at least one conductive ring makes electrical contact with the outer race and the housing and conducts electrical current between the outer race and the housing, and wherein the inner race rotates within the outer race.

8. The system of claim 7, wherein the inner race of each of the one or more bearings is in physical and electrical contact with the shaft.

9. The system of claim 7, wherein each of the one or more bearings has at least one interference ring positioned between the stator and the housing of the bearing, wherein the interference ring provides an interference fit between the housing and the stator.

10. The system of claim 9, wherein the at least one interference ring comprises an elastomeric T-ring.

11. The system of claim 7, wherein the system further comprises an electric submersible pump, wherein the motor is coupled to the pump and drives the pump.

12. The system of claim 7, further comprising, for each of the one or more bearings, a groove in an outer periphery of the outer race, wherein the at least one conductive ring is positioned within the groove.

13. The system of claim 7, wherein the at least one conductive ring of each of the one or more bearings comprises a coil spring.

14. The system of claim 13, wherein the coil spring has two ends that are joined together to form a loop around the outer race.

15. The system of claim 7, wherein the at least one conductive ring of each of the one or more bearings provides an interference fit between the outer race of the corresponding bearing and the housing, and wherein the at least one conductive ring prevents the outer race from rotating within the housing.

16. The system of claim 7, wherein the at least one conductive ring of each of the one or more bearings comprises a plurality of conductive rings, wherein each one of the plurality of conductive rings is positioned between the outer race of the corresponding bearing and the housing and is in electrical contact with the outer race and the housing.

17. A method for reducing electrical arcs between components of a bearing for an electric motor, the method comprising:
providing a bearing housing, an inner race and an outer race;
positioning at least one electrically conductive ring between the outer race and the housing, wherein the at least one conductive ring makes electrical contact with the outer race and the housing and conducts electrical current between the outer race and the housing;
positioning the inner race coaxially within the outer race, wherein the inner race rotates within the outer race; and
installing the bearing in an electric motor, wherein the bearing supports a shaft and a rotor within a stator bore and enables the shaft and rotor to rotate freely within the stator bore.

18. The method of claim 17, further comprising providing a groove in an outer periphery of the outer race and positioning the at least one conductive ring within the groove.

19. The method of claim 17, wherein the at least one conductive ring comprises a coil spring, wherein the coil spring has two ends that are joined together so that the coil spring forms a loop around the outer race.
